(19) United States
(12) Patent Application Publication
(10) Pub. No.: US 2012/0328816 A1
(43) Pub. Date: Dec. 27, 2012

(54) SAFETY DEVICE FOR BREAKING GLASS

(75) Inventors: JOHN A. SALENTINE, Goleta, CA (US); Kenneth S. Collin, JR., Ojai, CA (US)

(73) Assignee: HAMMERHEAD INDUSTRIES, INC.

(21) Appl. No.: 13/332,131

(22) Filed: Dec. 20, 2011

Related U.S. Application Data
(60) Provisional application No. 61/425,137, filed on Dec. 20, 2010.

(51) Int. Cl. A62B 3/00; B32B 33/00; B32B 3/06

(52) U.S. Cl. 428/40.1; 428/343; 428/355 EP; 225/1

(57) ABSTRACT

A quick, easy to use, and inexpensive device is disclosed for controlling most of the glass shards that can spread during the breaking of a window. A substrate material is mounted over the window by an adhesive, and the window is broken. The substrate material and adhesive are strong enough to hold the shards, and the substrate material with the window shards can be removed from the window area to allow for safe access through the window opening.

This application claims the benefit of U.S. Provisional Patent Application Ser. No. 61/425,137, to Salentine et al., filed on Dec. 20, 2010.

### BACKGROUND OF THE INVENTION

1. Field of the Invention

The present invention relates generally to glass handling safety equipment, and in particular a device that allows for breakage of glass while minimizing the spread of glass pieces and shards.

2. Description of the Related Art

In some emergency situations it can be necessary to break glass to gain access to a vehicle, residence of place of business. This can be necessary to avoid danger to humans and pets, as well as to avoid loss of property. For example, during emergency vehicle extrication, and other emergency situations encountered by firemen, emergency medical service personal, or law enforcement personal, it is often necessary to breakout and/or remove the windows in a vehicle. This is particularly critical when an injured occupant is trapped in the vehicle and/or could be subject to further harm if he/she remains in the vehicle.

Front windshields of most vehicles are designed to hold the glass shards in place when broken. Different technologies provide for this safety feature such as some windshields consisting of two (typically) curved sheets of glass with a plastic layer laminated between them for safety. However, most side and rear windows do not have these safety features and when broken can result in glass shards projecting out from the force of the break. Due to the curved design of windows, most often a large amount of the broken glass shards end up on the inside of the vehicle. When passengers remain in the vehicle at the time of breakage, it can be difficult, time consuming, and often times impossible, to properly protect the victim from being covered in glass shards when the windows are broken. The shards can also present a risk on injury to rescue personal when engaging in rescue activities, such as being cut by the glass.

### SUMMARY OF THE INVENTION

The present invention is directed to providing a quick, easy to use, and inexpensive device for controlling most of the glass shards that can spread during the breaking of a window. One embodiment of a safety device according to the present invention comprises a substrate material that can be mounted over the window by an adhesive, and the window can then be broken. The substrate material and adhesive are strong enough to hold the shards from the window, and the substrate material with the window shards can be removed from the window area to allow for safe access through the window opening.

One embodiment of a method for breaking a window, comprises providing a flexible substrate sized to substantially cover a window and adhering the substrate to the window. The window can then be broken, with the shards of the window held to the substrate by the adhesive. The substrate with shards of glass can then be removed.

These and other further features and advantages of the invention would be apparent to those skilled in the art from the following detailed description, taken together with the accompanying drawings, in which:

### BRIEF DESCRIPTION OF THE DRAWINGS

FIG. 1 is a perspective view of one embodiment of a glass safety device according to the present invention being applied to the back window of a vehicle;

FIG. 2 perspective view of the safety device in FIG. 1, being pressed in place on the window;

FIG. 3 is a perspective view of the safety device in FIGS. 1 and 2 with a glass breaking device used to break the window after the device is in place;

FIG. 4 is a perspective view of the safety device in FIG. 1-3 being removed after breaking the window; and

FIG. 5 is a perspective view of the safety device in FIGS. 1-4 after further removal.

### DETAILED DESCRIPTION OF THE INVENTION

The present invention is directed to a safety device that contains the spread of glass shards when breaking a window, with the device being safe, easy to use, and inexpensive. In some embodiments, a section of strong, flexible, and relatively thin substrate material is provided that is generally the shape of the window to be broken, such as in the case of a car window. In other embodiments, the holding material can be provided in larger sections and can be cuttable to fit the particular window. The substrate material should be flexible enough to allow for easy transport and application, but strong enough to hold the glass in place when the window is broken. The substrate material can comprise a transparent material to allow for viewing of through the substrate material and window during use, although this is not required. The substrate material should be robust enough so that a single sheet can be used that fits most window applications. Many different materials can be used for the substrate, with a suitable material being polyester. The substrate can be many different thicknesses, with some embodiments having thicknesses in the range of 0.02 to 0.10 mm. In some embodiments, the substrate can have a thickness of approximately 0.05 mm.

A first surface of the substrate material can comprise an adhesive that is capable of attaching the holding material to a window, and in some embodiments that adhesive can comprise and aggressive adhesive with a thickness that allows for good confirmity. Many adhesives can be used such as glues, epoxies, and silicones, with a suitable material being an acrylic. The adhesive can have many different thicknesses with some embodiments having a thickness in the range of 0.02 to 1.4 mm. In some embodiments, the adhesive can have a thickness of approximately 0.09 mm.

In other embodiments, the adhesive can be applied to the window, with the substrate then pressed on the window to the adhesive. The substrate material can be provided with a cover over the adhesive material, with the adhesive material being between the covering and the substrate. When the substrate is ready for use, the covering can be removed to expose the adhesive for mounting the substrate material to the window.

The second opposing surface of the substrate material can have a mechanism for holding the substrate material after the window has been broken. This can include handles, strings, straps or other holding means that allow for the user to grasp the holding material for removal with the glass pieces after the glass is broken. Other embodiments can be provided without holding mechanisms and the edge of the substrate material can be grasped to remove it with the broken glass. This, however, can require the user to wear safety gloves to avoid injury.

The substrate can be mounted to a window with the adhesive portion contacting the window, and the substrate pressed in place, either by hand or with a device such as a roller. When the substrate material is mounted in place, the window can be broken using different tools such as a window punch, hammer, or cutting device. As the window breaks it typically separates into shards, and the adhesive between the substrate material and the window holds the glass shards to the substrate material. This prevents most of the glass shards from spreading away from the breaking force, such as into a vehicle. The window can be removed from the vehicle window opening with a minimal amount of glass shards falling inside the vehicle, and in emergency situations, on the vehicle occupant(s). This also eliminates most of the glass shards from remaining in the opening of the window.

The present invention is applicable to being kept on hand in those situations where safe breaking of a vehicle, residence or business window can be necessary. For example, a supply can be kept on hand in fire trucks or police cars for the removal of car windows in emergency situations. The supply can comprise a plurality of individual folded or rolled substrates, or can comprise a roll or other larger quantity of substrate material that can be cut to size.

The present invention is described herein with reference to certain embodiments, but it is understood that the invention can be embodied in many different forms and should not be construed as limited to the embodiments set forth herein. The present invention is particularly applicable to any application where a window needs to be safely broken without the spread of shards. It is understood, however, that different embodiments can comprise many different materials arranged in different ways and can comprise different features of applying, using, storing and/or disposing of the substrate material.

It will be understood that when an element is referred to as being “on” or “in contact with” another element, it can be directly on, or in contact with the other element or intervening elements may be present. In contrast, when an element is referred to as being “directly on”, or “directly in contact with” another element, there are no intervening elements present. Although the terms first, second, etc. may be used herein to describe various elements, and/or sections, these elements and/or sections should not be limited by these terms. These terms are only used to distinguish one element, or section from another element, or section. Thus, a first element or section discussed herein could be termed a second element, or section without departing from the teachings of the present invention.

Embodiments of the invention are described herein with reference to perspective view illustrations that are schematic illustrations of an embodiment of the invention. As such, the actual thickness of components can be different, and variations from the shapes of the illustrations as a result, for example, of manufacturing techniques and/or tolerances are expected. Embodiments of the invention should not be construed as limited to the particular shapes as illustrated herein but are to include deviations in shapes that result, for example, from manufacturing. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

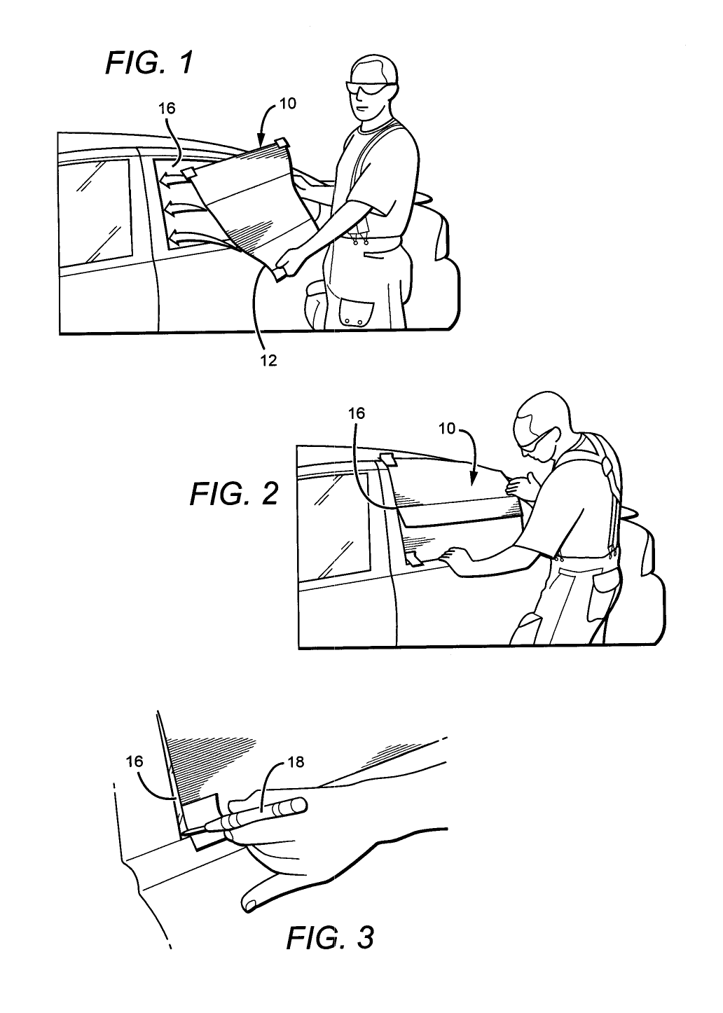

FIGS. 1 through 5 show one embodiment of a substrate material 10 according to the present invention during use in one of its many different applications. Referring first to FIG. 1, the substrate material 10 can be provided with an adhesive on its first surface 12, or in other embodiments an adhesive can be applied to the window 16 using known techniques. Some embodiments can be provided with a cover (not shown) over the first surface, with the adhesive between the substrate material 10 and the cover. The cover can be removed prior to mounting the substrate material to the window.

The substrate material 10 can be sized and aligned with the window 16 so that when mounted in place, substantially all of the window is covered. Further, the substrate material 10 can applied mainly to the window and not the window frame, except that in some embodiments it can be applied to the top of the frame. This allows the broken glass to be easily pulled as a single piece and pealed over the top of the vehicle and out of the way of rescue personnel. If complete removal of the window is required, the product can be easily cut along the top edges where it is adhered.

Referring now to FIG. 2, the substrate material 10 is pressed in place on the window 16 to be broken, with the adhesive holding the substrate material to the window 16. The window can then be broken, and in the embodiment shown in FIG. 3, a conventional window punch 18 can be used. The punch 18 can access the window 16 at one of the corners or the substrate material 10 can be cut or shaped such that a portion of the window remains accessible. As discussed above, when the window 16 is broken the shards of glass are held to the substrate material 10, and are not projected into the vehicle.

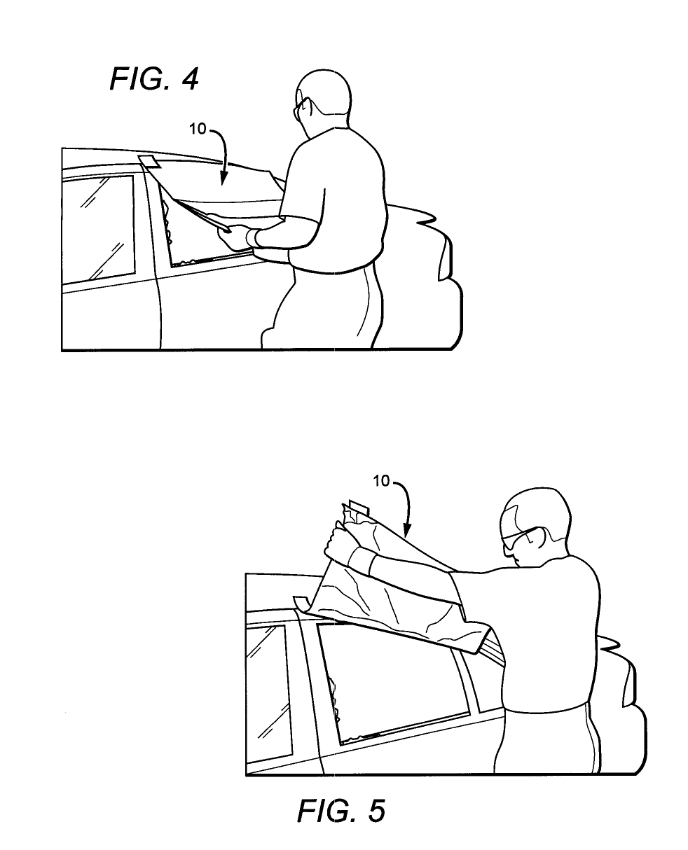

Referring now to FIG. 4, after the window 16 is broken the substrate material along with the window shards can be removed. This can be done by utilizing one of the holding means described above. In those embodiments not having a holding means, the substrate material can be grasped at its edges and lifted away from the window opening. Most of the pieces of the glass around the window frame are removed with the substrate material, and those remaining can be easily removed from the window frame.

Referring now to FIG. 5, the substrate material can be lifted from the window opening and folded back to the top of the vehicle along the substrate material that overlaps the top of the window frame and adheres to the top of the vehicle. This allows for the substrate material to be moved safely out of the way during access to the vehicle.

While several illustrative embodiments of the invention have been shown and described, numerous variations and alternate embodiments will occur to those skilled in the art, such as utilizing the present invention for LED decorative lighting or the like. Such variations and alternate embodiments are contemplated, and can be made without departing from the spirit and scope of the invention as defined in the appended claims.

We claim:

1. A safety device for use in breaking glass, comprising:
a flexible substrate material sized to cover the majority of a glass to be broken; and
an adhesive for holding said substrate to a said glass to be broken, said substrate and adhesive being strong enough to hold pieces of glass to said substrate following breaking of said glass to be broken.

2. The safety device of claim 1, wherein said adhesive comprises a material from the group including glues, epoxies and silicones.

3. The safety device of claim 1, wherein said substrate material comprises a holding mechanism.

4. The safety device of claim 3, wherein said holding mechanism comprises a handle, string or strap.

5. The safety device of claim 1, wherein said substrate material is transparent.

6. The safety device of claim 1, wherein said substrate material substantially covers the glass to be broken.

7. The safety device of claim 1, wherein said substrate material extends beyond the glass to be broken along at least one edge of the substrate material.

8. The safety device of claim 1, further comprising a cover over said adhesive.

9. A method for breaking a window, comprising:
providing a flexible substrate sized to substantially cover a window;
adhering said substrate to said window;
breaking said window, the shards of said window held to said substrate by said adhesive; and
removing said substrate with said shards of glass.

10. The method of claim 9, wherein said adhering comprises providing an adhesive between said substrate and said window.

11. The method of claim 10, wherein said adhesive comprises a material from the group including glues, epoxies and silicones.

12. The method of claim 9, further comprising providing a holding mechanism for said substrate material.

13. The method of claim 12, wherein said holding mechanism comprises a handle, string or strap.

14. The method of claim 9, wherein said substrate material is transparent.

15. The method of claim 9, wherein said substrate material extends to a frame around said window along at least one edge of the substrate material.

16. The method of claim 15, further comprising folding said substrate material out of said frame by folding said substrate material along said extension.

17. A safety device for use breaking a car window, comprising:
a flexible substrate material sized to cover the majority of a vehicle window;
an adhesive for holding said substrate to a said vehicle window, said substrate and adhesive being strong enough to hold pieces of window to said substrate following breaking of said window; and
a handle for holding said substrate material.

18. The device of claim 17, wherein said substrate material is transparent.

19. The device of claim 17, wherein said substrate material extends to a frame around said window along at least one edge of the substrate material.

20. The device of claim 19, wherein said substrate can be removed from aid frame by folding said substrate material along said extension.
